(19) United States
(12) Patent Application Publication
(10) Pub. No.: US 2025/0008317 A1
(43) Pub. Date: Jan. 2, 2025

(54) WIRELESS COMMUNICATION METHOD AND DEVICE

(71) Applicant: BEIJING XIAOMI MOBILE SOFTWARE CO., LTD., Beijing (CN)

(72) Inventor: Dong CHEN, Beijing (CN)

(73) Assignee: BEIJING XIAOMI MOBILE SOFTWARE CO., LTD., Beijing (CN)

(21) Appl. No.: 18/708,988

(22) PCT Filed: Nov. 10, 2021
(86) PCT No.: PCT/CN2021/129826

§ 371 Date: May 9, 2024

(51) Int. Cl. H04W 8/22; H04W 52/02

(52) U.S. Cl. CPC H04W 8/22; H04W 52/0261

(57) ABSTRACT

The present disclosure relates to a wireless communication method and device. In the method applied in a terminal, a wireless communication capability supported by the terminal is determined and reported. The wireless communication capability includes at least one of a wireless charging capability or a wireless sensing capability.

### CROSS-REFERENCE TO RELATED APPLICATIONS

The present application is a U.S. National Stage of International Application No. PCT/CN2021/129826 filed on Nov. 10, 2021, the entire contents of which are incorporated herein by reference for all purposes.

### BACKGROUND

A mobile communication system is a radio communication system. In the radio communication system, a radio wave is mainly used for transmitting information. The existing mobile communication system mainly includes a cellular system, a trunking system, a pear-to-pear (AdHoc) network system, a satellite communication system, a packet radio network, a cordless telephone system, a radio paging system or the like. At present, the mobile communication mostly operates in a complex interference environment, the demand for the mobile communication services is increasing, and the functions of mobile communication services are becoming more and more diversified.

In the related art, as the functions of mobile communication services becomes diversified, a wireless charging technology and a sensing technology for radio detection and ranging have been introduced. As a result, the number of mobile terminals that support wireless charging and sensing functions is increasing.

### SUMMARY

The present disclosure relates to the field of communication technology, and more specifically, to a wireless communication method, device and storage medium.

According to a first aspect of the present disclosure, some embodiments provide a wireless communication method applied to a terminal, including:

determining a wireless communication capability supported by the terminal, the wireless communication capability including a wireless charging capability and/or a wireless sensing capability; and reporting the wireless communication capability.

According to a second aspect of the present disclosure, some embodiments provide a wireless communication method applied to a network device, including: receiving a wireless communication capability reported by a terminal, the wireless communication capability including a wireless charging capability and/or a wireless sensing capability.

According to a third aspect of the present disclosure, some embodiments provide a wireless communication device, including:
a processing unit configured to determine a wireless communication capability supported by a terminal, the wireless communication capability including a wireless charging capability and/or a wireless sensing capability; and a transmitting unit configured to report the wireless communication capability.

According to a fourth aspect of the present disclosure, some embodiments provide a wireless communication device, including:
a receiving unit configured to receive a wireless communication capability reported by a terminal, the wireless communication capability including a wireless charging capability and/or a wireless sensing capability.

According to a fifth aspect of the present disclosure, some embodiments provide a wireless communication device, including: a processor; and a memory storing instructions executable by the processor, wherein the processor is configured to perform the method according to the first aspect or any embodiment thereof.

According to a sixth aspect of the present disclosure, some embodiments provide a wireless communication device, including: a processor; and a memory storing instructions executable by the processor, wherein the processor is configured to perform the method according to the second aspect or any embodiment thereof.

According to a seventh aspect of the present disclosure, some embodiments provide a storage medium having instructions stored thereon that, when being executed by a processor of a terminal, cause the terminal to perform the method according to the first aspect or any embodiment thereof.

According to an eighth aspect of the present disclosure, some embodiments provide a storage medium having instructions stored thereon that, when being executed by a processor of a network device, cause the network device to perform the method according to the second aspect or any embodiment thereof.

The above general description and the following detailed descriptions are exemplary and explanatory only and do not limit the present disclosure.

### BRIEF DESCRIPTION OF THE DRAWINGS

The accompanying drawings herein, which are incorporated into and form a part of the specification, illustrate embodiments consistent with the present disclosure and are used in conjunction with the specification to explain the principle of the present disclosure.

FIG. 1 is a schematic diagram of a wireless communication system according to an embodiment of the present disclosure.

FIG. 2 is a flowchart of a wireless communication method according to an embodiment of the present disclosure.

FIG. 3 is a flowchart of a wireless communication method according to an embodiment of the present disclosure.

FIG. 4 is a flowchart of a wireless communication method according to an embodiment of the present disclosure.

FIG. 5 is a flowchart of a wireless communication method according to an embodiment of the present disclosure.

FIG. 6 is a flowchart of a wireless communication method according to an embodiment of the present disclosure.

FIG. 7 is a flowchart of a wireless communication method according to an embodiment of the present disclosure.

FIG. 8 is a flowchart of a wireless communication method according to an embodiment of the present disclosure.

FIG. 9 is a flowchart of a wireless communication method according to an embodiment of the present disclosure.

FIG. 10 is a flowchart of a wireless communication method according to an embodiment of the present disclosure.

FIG. 11 is a flowchart of a wireless communication method according to an embodiment of the present disclosure.

FIG. 12 is a flowchart of a wireless communication method according to an embodiment of the present disclosure.

FIG. 13 is a block diagram of a wireless communication device according to an embodiment of the present disclosure.

FIG. 14 is a block diagram of a wireless communication device according to an embodiment of the present disclosure.

FIG. 15 is a block diagram of a device for wireless communication according to an embodiment of the present disclosure.

FIG. 16 is a block diagram of a device for wireless communication according to an embodiment of the present disclosure.

### DETAILED DESCRIPTION

Exemplary embodiments will be described herein in detail, examples of which are illustrated in the accompanying drawings. When the following description is made with reference to the accompanying drawings, the same reference numerals in different accompanying drawings indicate the same or similar elements unless otherwise indicated. The implementations described in the following embodiments do not represent all implementations consistent with the present disclosure.

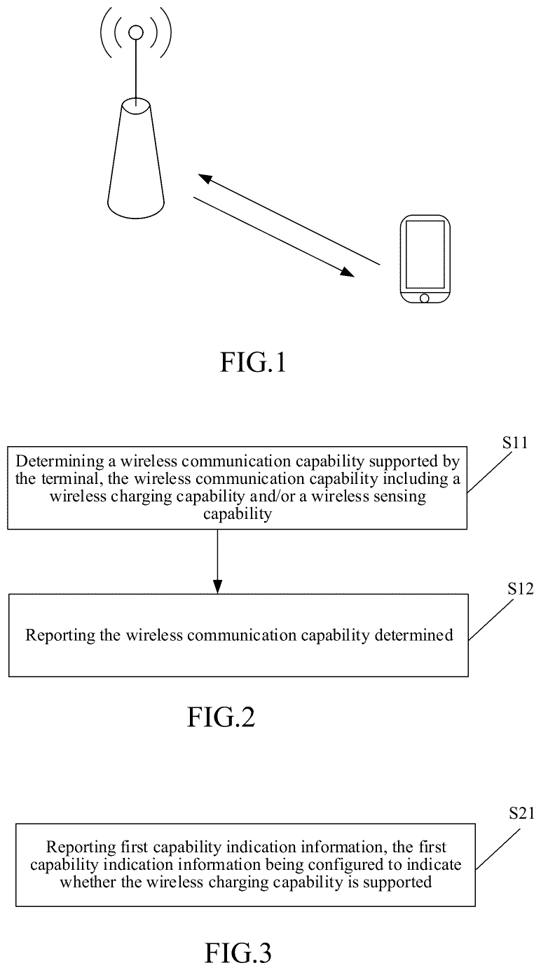

Embodiments of the present disclosure provide a wireless communication method that may be applied in a wireless communication system shown in FIG. 1. Referring to FIG. 1, the wireless communication system shown includes a terminal and a network device. The terminal is connected to the network device via a wireless resource, and transmits and receives data.

The wireless communication system shown in FIG. 1 is for schematic illustration only, and other network devices may be included in the wireless communication system, for example, a core network device, a wireless relay device, and a wireless backhaul device may further be included, which are not shown in FIG. 1. The number of network devices and the number of terminals included in the wireless communication system are not limited in the embodiments of the present disclosure.

The wireless communication system in embodiments of the present disclosure is a network providing a wireless communication function. The wireless communication system may employ different communication technologies, such as Code Division Multiple Access (CDMA), Wideband Code Division Multiple Access (WCDMA), Time Division Multiple Access (TDMA), Frequency Division Multiple Access (FDMA), Orthogonal Frequency-Division Multiple Access (OFDMA), Single Carrier FDMA (SC-FDMA), Carrier Sense Multiple Access with Collision Avoidance. Depending on the capacity, rate, latency, and other factors of different networks, the networks may be classified into a 2G (Generation) network, a 3G network, a 4G network, or a future evolution network, such as a 5G network, which can also be referred to as a New Radio (NR) network. For ease of description, a wireless communication network may be simply referred to as a network in the present disclosure.

Further, the network device involved in the present disclosure may also be referred to as a wireless access network device. The wireless access network device may be a base station, an evolved Node B (eNB), a home base station, an Access Point (AP) in a Wireless Fidelity (WIFI) system, a wireless relay node, a wireless backhaul node, a Transmission Point (TP) or Transmission and Reception Point (TRP) or the like, may also be a gNB in a NR system, or may be a component or part that constitutes a base station, or the like. The network device may also be an in-vehicle device when being in a Vehicle to Everything (V2X) communication system. The specific technology and the specific device form for the network device are not limited in the embodiments of the present disclosure.

Further, the terminal involved in the present disclosure may also be referred to as a terminal device, User Equipment (UE), Mobile Station (MS), Mobile Terminal (MT) or the like, which is a device that provides voice and/or data connectivity to a user, for example, the terminal may be a handheld device and an in-vehicle device with a wireless connectivity function or the like. Currently, some examples of terminals are: a mobile phone, a pocket personal computer (PPC), a palmtop computer, a personal digital assistant (PDA), a laptop computer, a tablet computer, a wearable device, an in-vehicle devices, or the like. In addition, the terminal device may also be an in-vehicle device when being in a Vehicle to Everything (V2X) communication system. The specific technology and the specific device form for the terminal device are not limited in the embodiments of the present disclosure.

In the related art, a wireless charging technology and a wireless sensing technology are introduced in the wireless communication system.

The wireless charging technology may be also referred to as Wireless Charge Technology. The wireless charging technology is derived from the wireless energy transmission technology, and may be divided into two modes, i.e., low power wireless charging and high power wireless charging. The low power wireless charging often uses electromagnetic induction, for example, most mobile terminals such as mobile phones are charged in this mode. The high power wireless charging often uses a resonant mode, for example, most electric vehicles are charged in the resonant mode. In the high power wireless charging, energy is transmitted from a power supply device (charger) to a power-using device. The power-using device uses the energy received to charge the battery and at the same time to operate the power-using device itself.

In the wireless charging technology, since the charger and the power-using device use a magnetic field to transmit energy and thus no wires are connected between the charger and the power-using device, both the charger and the power-using device have no exposed conductive contacts.

The wireless sensing technology is also known as a sensing system or radar. The English name “Radar” of the wireless sensing technology is the English abbreviation of Radio Detection and Ranging. In some embodiments, the wireless sensing technology may use a radio method to detect targets and determine spatial locations thereof. Therefore, radar is also known as “radio positioning”. Radar uses electromagnetic waves to detect a target electronic device. Radar emits electromagnetic waves to irradiate the target electronic device and receives return waves from the target electronic device, thereby obtaining information such as distance from the target electronic device to the emission point of the electromagnetic waves, range rate (radial velocity), orientation, and altitude.

The wireless charging function and the wireless sensing function have been widely used in mobile terminals such as mobile phones, but not all terminals support the wireless charging function and/or the wireless sensing function. Some terminals support the wireless charging function and/or the wireless sensing function, and some terminals do not support the wireless charging function and/or the wireless sensing function. In a wireless communication system, a terminal interacts and communicates with a network device, and the network device determines whether the terminal supports the wireless charging function and/or the wireless sensing function in order to configure corresponding functions to ensure communication performance.

An embodiment of the present disclosure provides a wireless communication method in which a terminal reports a supported wireless communication capability so that a network device determines the wireless communication capability supported by the terminal and improves the communication performance.

FIG. 2 is a flowchart of a wireless communication method according to an embodiment. As shown in FIG. 2, the wireless communication method is applied in a terminal and includes:
step S11, determining a wireless communication capability supported by the terminal, the wireless communication capability including a wireless charging capability and/or a wireless sensing capability; and
step S12, reporting the wireless communication capability determined.

In an embodiment of the present disclosure, the terminal determines whether a predetermined wireless communication capability is supported, for example, whether the terminal supports a wireless charging capability, and/or whether the terminal supports a wireless sensing capability.

In an embodiment of the present disclosure, when the terminal reports the wireless communication capability, the wireless communication capability may be carried in terminal capability information (UECapabilityInformation). In an example, according to an embodiment of the present disclosure, a new bit for indicating the wireless communication capability may be added into the UECapabilityInformation, for example, one or more bits may be added to indicate whether the terminal supports the predetermined wireless communication capability.

In an embodiment of the present disclosure, the terminal reports the related capability indication information regarding whether the terminal supports the wireless communication capability to the network device, so that the network device determines whether the terminal supports the related wireless communication capability based on the capability indication information.

In an example, the indication information reported by the terminal to the network device to indicate whether a wireless charging capability is supported is referred to as first capability indication information hereinafter. The first capability indication information is used to indicate whether the wireless charging capability is supported.

In the embodiment of the present disclosure, the terminal reports a wireless communication capability indicating whether the terminal supports a wireless charging capability and/or a wireless sensing capability, so that the network device determines whether the terminal supports a wireless charging function and/or a wireless sensing function so as to make a corresponding function configuration, which ensures a communication performance.

FIG. 3 is a flowchart of a wireless communication method according to an embodiment, which may be implemented alone or in combination with other embodiments of the present disclosure. As shown in FIG. 3, the wireless communication method is applied in the terminal and includes:
step S21, reporting first capability indication information, the first capability indication information being configured to indicate whether the wireless charging capability is supported.

In an embodiment of the present disclosure, the terminal reports the first capability indication information indicating whether the wireless charging capability is supported to the network device. After receiving the first capability indication information, the network device determines whether the terminal supports the wireless charging capability based on the first capability indication information, so as to make a configuration for that the wireless charging capability is supported when determining that the wireless charging capability is supported, and make a configuration for that the wireless charging capability is not supported when determining that the wireless charging capability is not supported.

In an embodiment of the present disclosure, when the terminal reports the first capability indication information, the first capability indication information may be carried in the UECapabilityInformation. In an example, according to an embodiment of the present disclosure, a new bit for indicating the first capability indication information may be added into the UECapabilityInformation, for example, one or more bits may be added to indicate whether the terminal supports the wireless charging capability.

Further, in an embodiment of the present disclosure, the terminal may further determine whether a wireless charging function is enabled when the terminal determines that the wireless charging capability is supported. Therefore, in an embodiment of the present disclosure, in response to the terminal determining that the wireless charging capability is supported, the terminal may further report indication information indicating whether the wireless charging function is enabled, which is referred to as first function enablement indication information hereinafter.

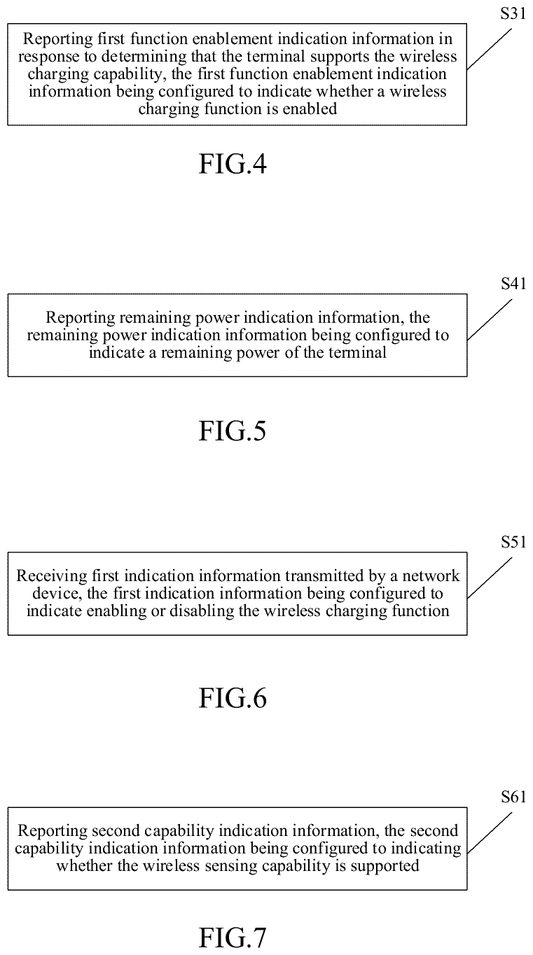

FIG. 4 is a flowchart of a wireless communication method according to an embodiment, and the wireless communication method may be implemented alone or in combination with other embodiments of the present disclosure. As shown in FIG. 4, the wireless communication method is applied in the terminal and includes:
step S31, reporting first function enablement indication information in response to determining that the terminal supports the wireless charging capability, the first function enablement indication information being configured to indicate whether a wireless charging function is enabled.

In an embodiment of the present disclosure, the terminal supporting the wireless charging capability reports the first function enablement indication information to the network device so as to report whether the wireless charging function is enabled. The network device receives the first function enablement indication information, and based on the first function enablement indication information, makes a corresponding configuration for the wireless charging function.

In an embodiment of the present disclosure, when the terminal reports the first function enablement indication information, the first function enablement indication information may be carried in the UECapability Information. In an example, according to an embodiment of the present disclosure, a new bit for indicating the first function enablement indication information may be added into the UECapability Information, for example, one or more bits may be added to indicate whether the terminal enables the wireless charging function.

Further, in an embodiment of the present disclosure, the terminal supporting the wireless charging capability may report a remaining power of the terminal to enable the network device to control a subsequent charging operation of the terminal based on the remaining power.

FIG. 5 is a flowchart of a wireless communication method according to an embodiment, and the wireless communication method may be implemented alone or in combination with other embodiments of the present disclosure. As shown in FIG. 5, the wireless communication method is applied in the terminal and includes:
step S41, reporting remaining power indication information, the remaining power indication information being configured to indicate a remaining power of the terminal.

In an embodiment of the present disclosure, the terminal reports the remaining power indication information, so that the network device determines the remaining power of the terminal and gives a corresponding configuration indication based on the remaining power, for example, to control whether to charge the terminal.

In an embodiment of the present disclosure, the terminal may report the remaining power indication information when a power level is lower than a set power threshold, or may periodically report the remaining power indication information in accordance with a set cycle, which however is not specifically limited in the embodiments of the present disclosure.

In an embodiment of the present disclosure, when the terminal reports the remaining power indication information, the remaining power indication information may be carried in the UECapabilityInformation. In an example, according to an embodiment of the present disclosure, a new bit for indicating the remaining power indication information may be added into the UECapabilityInformation, for example, one or more bits may be added to indicate the remaining power of the terminal.

In yet another embodiment of the present disclosure, the network device may also transmit, to the terminal, indication information indicating whether to enable a function. For example, the network device may transmit, to the terminal, indication information for enabling or disabling the wireless charging function, which is referred to as first indication information hereinafter.

FIG. 6 is a flowchart of a wireless communication method according to an embodiment, which may be implemented alone or in combination with other embodiments of the present disclosure. As shown in FIG. 6, the wireless communication method is applied in the terminal and includes:
step S51, receiving first indication information transmitted by a network device, the first indication information being configured to indicate enabling or disabling the wireless charging function.

In an embodiment of the present disclosure, the network device instructs the terminal to enable the wireless charging function or disable the wireless charging function through the first indication information.

In an example, when determining that the remaining power of the terminal is lower than a first threshold value, the network device may transmit, to the terminal, the first indication information to indicate enabling the wireless charging function, so that the terminal may be charged in a timely manner.

In another example, when determining that the remaining power of the terminal is higher than a second threshold value, the network device may transmit, to the terminal, the first indication information indicating disabling the wireless charging function to save power consumption.

The first indication information may be a signaling (an instruction transmitted by the network device to the terminal) transmitted by the network device to the terminal.

In an embodiment of the present disclosure, the capability reporting by the terminal to the network device includes the first capability indication information indicating whether the wireless charging capability is supported, and if the wireless charging capability is supported, further includes the first function enablement indication information indicating whether the wireless charging function is enabled. In addition, the network device may also enable or disable the wireless charging function of the terminal through signaling (the first indication information), so as to enhance wireless charging technology-based communication in wireless communication.

In another example, the terminal reports, to the network device, indication information indicating whether the wireless sensing capability is supported, which is referred to as second capability indication information hereinafter. The second capability indication information is configured to indicate whether the wireless sensing capability is supported.

FIG. 7 is a flowchart of a wireless communication method according to an embodiment, which may be implemented alone or in combination with other embodiments of the present disclosure. As shown in FIG. 3, the wireless communication method is applied in the terminal and includes:
step S61, reporting second capability indication information, the second capability indication information being configured to indicating whether the wireless sensing capability is supported.

In an embodiment of the present disclosure, the terminal reports the second capability indication information indicating whether the wireless sensing capability is supported to the network device. After receiving the second capability indication information, the network device determines whether the terminal supports the wireless sensing capability based on the second capability indication information, so as to make a configuration for that the wireless sensing capability is supported when determining that the wireless sensing capability is supported, and make a configuration for that the wireless sensing capability is not supported when determining that the wireless sensing capability is not supported.

In an embodiment of the present disclosure, when the terminal reports the second capability indication information, the second capability indication information may be carried in the UECapabilityInformation. In an example, according to an embodiment of the present disclosure, a new bit for indicating the second capability indication information may be added into the UECapabilityInformation, for example, one or more bits may be added to indicate whether the terminal supports the wireless sensing capability.

Further, in an embodiment of the present disclosure, the terminal may further determine whether a wireless sensing function is enabled when the terminal determines that the wireless sensing capability is supported. Therefore, in an embodiment of the present disclosure, in response to the terminal determining that the wireless sensing capability is supported, the terminal may further report indication information indicating whether the wireless sensing function is enabled, which is referred to as second function enablement indication information hereinafter.

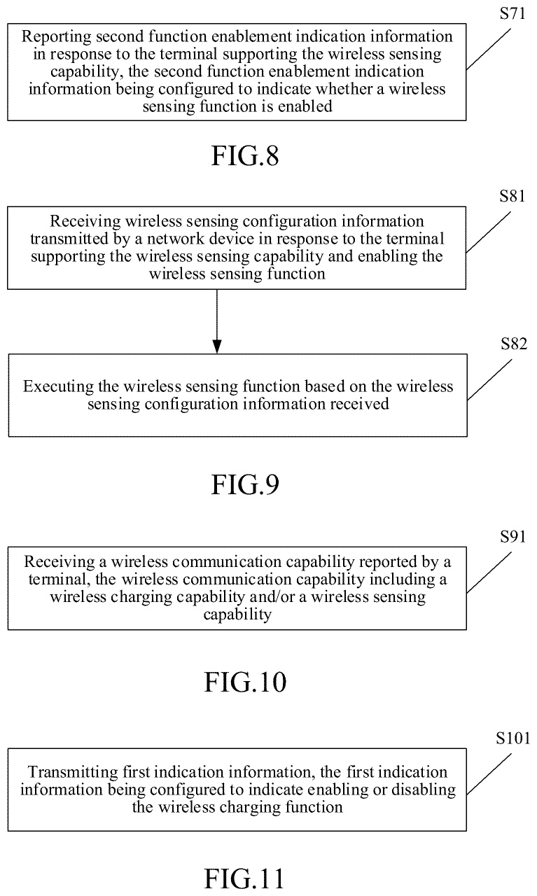

FIG. 8 is a flowchart of a wireless communication method according to an embodiment, and the wireless communication method may be implemented alone or in combination with other embodiments of the present disclosure. As shown in FIG. 8, the wireless communication method is applied in the terminal and includes:
step S71, reporting second function enablement indication information in response to the terminal supporting the wireless sensing capability, the second function enablement indication information being configured to indicate whether a wireless sensing function is enabled.

In an embodiment of the present disclosure, the terminal supporting the wireless sensing capability reports the second function enablement indication information to the network device so as to report whether the wireless sensing function is enabled. The network device receives the second function enablement indication information, and based on the second function enablement indication information, makes a corresponding configuration for the wireless sensing function.

In an embodiment of the present disclosure, when the terminal reports the second function enablement indication information, the second function enablement indication information may be carried in the UECapabilityInformation. In an example, according to an embodiment of the present disclosure, a new bit for indicating the second function enablement indication information may be added into the UECapabilityInformation, for example, one or more bits may be added to indicate whether the terminal enables the wireless sensing function.

In an embodiment of the present disclosure, in response to the terminal supporting the wireless sensing capability and enabling the wireless sensing function, the network device configures resources used for sensing and configures the sensing process (e.g., power control) and the like on the premise that the sensing function of the terminal is supported and enabled. The terminal receives corresponding configuration information and implements the corresponding sensing function in accordance with the received configuration.

FIG. 9 is a flowchart of a wireless communication method according to an embodiment, which may be implemented alone or in combination with other embodiments of the present disclosure. As shown in FIG. 9, the wireless communication method is applied in the terminal and includes:
step S81, receiving wireless sensing configuration information transmitted by a network device in response to the terminal supporting the wireless sensing capability and enabling the wireless sensing function; and
step S82, executing the wireless sensing function based on the wireless sensing configuration information received.

In an embodiment of the present disclosure, the capability reporting by the terminal to the network device includes the second capability indication information indicating whether the wireless sensing capability is supported, and if the wireless sensing capability is supported, further includes the second function enablement indication information indicating whether the wireless sensing function is enabled. In addition, the network device may configure resources for sensing, therefore, the present disclosure can enhance wireless sensing technology-based communication in wireless communication.

In an embodiment of the present disclosure, the wireless communication process based on the wireless charging capability and the wireless communication process based on the wireless sensing capability may be implemented independently or in combination with each other. For example, in an embodiment of the present disclosure, the terminal may report the first capability indication information and/or the second capability indication information. When the terminal reports the first capability indication information and the second capability indication information, the first capability indication information and the second capability indication information may be carried in the UECapability Information. In an embodiment of the present disclosure, the terminal may report the first function enablement indication information and/or the second function enablement indication information. When the terminal reports the first function enablement indication information and/or the second function enablement indication information, the first function enablement indication information and/or the second function enablement indication information may be carried in the UECapability Information.

Based on the same idea, an embodiment of the present disclosure also provides a wireless communication method applied to a network device.

FIG. 10 is a flowchart of a wireless communication method according to an embodiment, which may be implemented alone or in combination with other embodiments of the present disclosure. As shown in FIG. 10, the wireless communication method is applied in a network device and includes:
step S91, receiving a wireless communication capability reported by a terminal, the wireless communication capability including a wireless charging capability and/or a wireless sensing capability.

In an embodiment of the present disclosure, the network device receives relevant capability indication information as to whether the wireless communication capability is supported, and based on the capability indication information, can determine whether the terminal supports the relevant wireless communication capability, and then make subsequent relevant configuration.

In an embodiment, the network device receives first capability indication information, and the first capability indication information is configured to indicate whether the wireless charging capability is supported, and/or in another embodiment, the network device receives second capability indication information, and the second capability indication information is configured to indicate whether the wireless sensing capability is supported.

After receiving the first capability indication information, the network device determines whether the terminal supports the wireless charging capability based on the first capability indication information, so as to make a configuration for that the wireless charging capability is supported when determining that the wireless charging capability is supported, and make a configuration for that the wireless charging capability is not supported when determining that the wireless charging capability is not supported.

After receiving the second capability indication information, the network device determines whether the terminal supports the wireless sensing capability based on the second capability indication information, so as to make a configuration for that the wireless sensing capability is supported when determining that the wireless sensing capability is supported, and make a configuration for that the wireless sensing capability is not supported when determining that the wireless sensing capability is not supported.

In an embodiment, the first capability indication information and/or the second capability indication information is carried in the UECapabilityInformation. The network device receives the UECapabilityInformation which carries the first capability indication information and/or the second capability indication information.

In an embodiment of the present disclosure, on the one hand, the network device may also receive first function enablement indication information reported by the terminal, and the first function enablement indication information is configured to indicate whether the wireless charging function is enabled. The network device receives the first function enablement indication information, and based on the first function enablement indication information, makes a corresponding configuration for the wireless charging function.

In an embodiment, the first function enablement indication information is carried in the UECapability Information. The network device receives the UECapabilityInformation which carries the first function enablement indication information.

On the other hand, the network device receives second function enablement indication information reported by the terminal, and the second function enablement indication information is configured to indicate whether the wireless sensing function is enabled. The network device receives the second function enablement indication information, and based on the second function enablement indication information, makes a corresponding configuration for the wireless sensing function.

In an embodiment, the second function enablement indication information is carried in the UECapability Information. The network device receives the UECapability Information which carries the second function enablement indication information.

In another embodiment, the network device may also receive remaining power indication information reported by the terminal. The network device determines the remaining power of the terminal and gives a corresponding configuration indication based on the remaining power, which, for example, may control whether to charge the terminal or the like.

FIG. 11 is a flowchart of a wireless communication method according to an embodiment, which may be implemented alone or in combination with other embodiments of the present disclosure. As shown in FIG. 11, the wireless communication method is applied in the network device and includes:
step S101, transmitting first indication information, the first indication information being configured to indicate enabling or disabling the wireless charging function.

The first indication information may be a signaling transmitted by the network device to the terminal (or may be an instruction transmitted by the network device to the terminal).

In an embodiment of the present disclosure, the network device transmits the first indication information to the terminal to control the wireless charging function of the terminal.

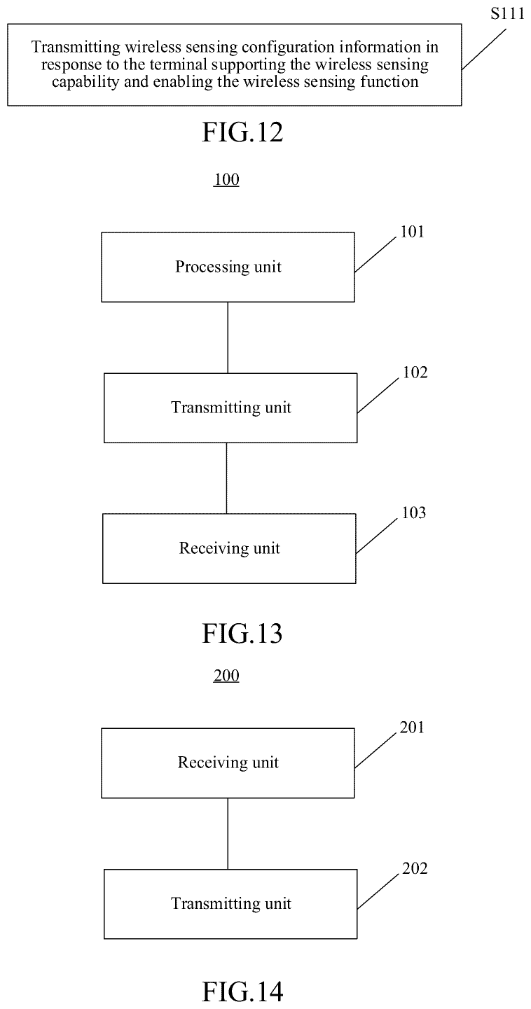

FIG. 12 is a flowchart of a wireless communication method according to an embodiment, and the wireless communication method may be implemented alone or together with other embodiments of the present disclosure. As shown in FIG. 12, the wireless communication method is applied in the network device and includes:
In step S111, transmitting wireless sensing configuration information in response to the terminal supporting the wireless sensing capability and enabling the wireless sensing function.

In an embodiment of the present disclosure, the network device configures resources used for the wireless sensing function of the terminal and controls the wireless sensing function by transmitting the wireless sensing configuration information to the terminal.

The wireless communication method applied to the network device in the embodiments of the present disclosure is similar to the process of the wireless communication method performed by the terminal, so where the description of the process of the wireless communication method performed by the network device is not exhaustive, it may refer to the description of the forgoing relevant embodiments, which is not repeated herein.

The wireless communication method provided in the embodiments of the present disclosure is also applicable to the interaction process between the terminal and the network device. In the relevant wireless communication capability reporting involved in the wireless communication process realized by the interaction between the terminal and the network device, the terminal and the network device each have the relevant functions of the above embodiments, which therefore will not be described in detail herein.

The above various implementations/examples involved in the embodiments of the present disclosure may be used in conjunction with the aforementioned embodiments or alone. Whether used alone or in conjunction with the aforementioned embodiments, the implementation principles thereof are similar. When implementing the present disclosure, some embodiments are illustrated in a manner that they are used together. Such illustration is not a limitation of the embodiments of the present disclosure.

Based on the same idea, an embodiment of the present disclosure also provides a wireless communication device.

In some embodiments of the present disclosure, to realize the above-described functions, the wireless communication device may include a hardware structure and/or a software module for executing each corresponding function. In combination with the units and algorithmic steps of the various examples disclosed in the embodiments of the present disclosure, the embodiments of the present disclosure can be implemented in the form of hardware or a combination of hardware and computer software. Whether a particular function is implemented by hardware or computer software driving hardware depends on the particular application and design constraints of the technical solution. In some embodiments, different methods may be used to implement the described function for each particular application, but such implementation should not be considered outside the scope of the technical solutions of the embodiments of the present disclosure.

FIG. 13 is a block diagram of a wireless communication device according to an embodiment. Referring to FIG. 13, the wireless communication device 100 may be provided as a terminal involved in the above embodiment, and includes a processing unit 101 and a transmitting unit 102.

The processing unit 101 is configured to determine a wireless communication capability supported by a terminal, the wireless communication capability including a wireless charging capability and/or a wireless sensing capability; and the transmitting unit 102 is configured to report the wireless communication capability.

In an embodiment, the transmitting unit 102 reports first capability indication information, the first capability indication information being configured to indicate whether the wireless charging capability is supported; and/or report second capability indication information, the second capability indication information being configured to indicating whether the wireless sensing capability is supported.

In an embodiment, the transmitting unit 102 reports first function enablement indication information in response to the processing unit 101 determining that the terminal supports the wireless charging capability, the first function enablement indication information being configured to indicate whether a wireless charging function is enabled.

In an embodiment, the transmitting unit 102 reports remaining power indication information.

In an embodiment, the wireless communication device 100 further includes a receiving unit 103 configured to receive first indication information transmitted by a network device, and the first indication information is configured to indicate enabling or disabling the wireless charging function.

In an embodiment, the transmitting unit 102 reports second function enablement indication information in response to the processing unit 101 determining that the terminal supports the wireless sensing capability, and the second function enablement indication information is configured to indicate whether a wireless sensing function is enabled.

In an embodiment, the wireless communication device 100 further includes a receiving unit 103 configured to receive wireless sensing configuration information transmitted by a network device in response to the terminal supporting the wireless sensing capability and enabling the wireless sensing function; and execute the wireless sensing function based on the wireless sensing configuration information.

In an embodiment, the transmitting unit 102 reports terminal capability information, the terminal capability information carrying the wireless communication capability.

FIG. 14 is a block diagram of a wireless communication device according to an embodiment. Referring to FIG. 14, the wireless communication device 200 may be provided as a network device involved in the above embodiments, and includes a receiving unit 201.

The receiving unit 201 is configured to receive a wireless communication capability reported by a terminal, and the wireless communication capability includes a wireless charging capability and/or a wireless sensing capability.

In an embodiment, the receiving unit 201 receives first capability indication information, the first capability indication information being configured to indicate whether the wireless charging capability is supported; and/or receives second capability indication information, the second capability indication information being configured to indicate whether the wireless sensing capability is supported.

In an embodiment, the receiving unit 201 is further configured to receive first function enablement indication information reported by the terminal, and the first function enablement indication information is configured to indicate whether a wireless charging function is enabled.

In an embodiment, the receiving unit 201 is further configured to receive remaining power indication information reported by the terminal.

In an embodiment, the wireless communication device 200 further includes a transmitting unit 202 configured to transmit first indication information, and the first indication information is configured to indicate enabling or disabling the wireless charging function.

In an embodiment, the receiving unit 201 receives second function enablement indication information reported by the terminal, and the second function enablement indication information is configured to indicate whether a wireless sensing function is enabled.

In an embodiment, the wireless communication device 200 further includes a transmitting unit 202 configured to transmit wireless sensing configuration information in response to the terminal supporting the wireless sensing capability and enabling the wireless sensing function.

In an embodiment, the receiving unit 201 is configured to receive terminal capability information, and the terminal capability information carries the wireless communication capability.

With respect to the device in the above embodiment, the specific manner in which each module performs an operation has been described in detail in the embodiments relating to the method, and will not be described in detail herein.

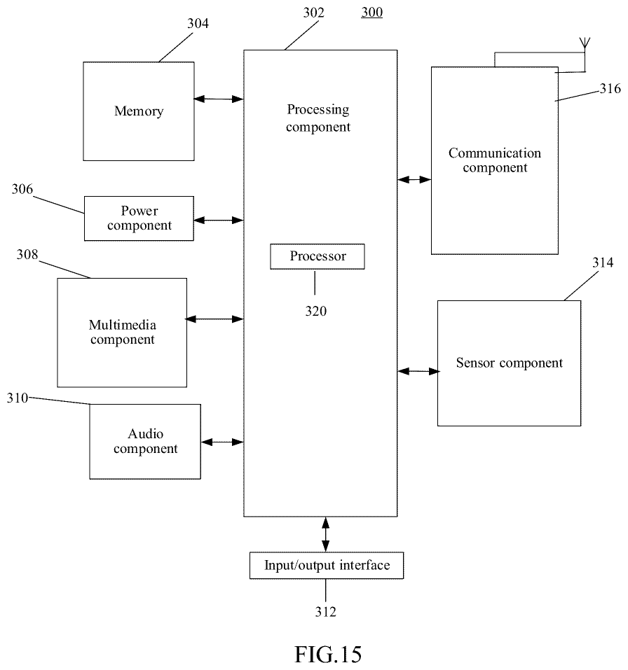

FIG. 15 is a block diagram of a device 300 for wireless communication according to an embodiment. For example, the device 300 may be a mobile phone, a computer, a digital broadcasting terminal, a messaging device, a game console, a tablet device, a medical device, a fitness device, a personal digital assistant, or the like.

Referring to FIG. 15, the device 300 may include one or more of a processing component 302, a memory 304, a power component 306, a multimedia component 308, an audio component 310, an input/output (I/O) interface 312, a sensor component 314, and a communication component 316.

The processing component 302 generally controls the overall operations of the device 300, such as operations associated with display, telephone calls, data communications, camera operations, and recording operations. The processing component 302 may include one or more processors 320 to execute instructions to complete all or part of the steps of the foregoing method. In addition, the processing component 302 may include one or more modules to facilitate interaction between the processing component 302 and other components. For example, the processing component 302 may include a multimedia module to facilitate the interaction between the multimedia component 308 and the processing component 302.

The memory 304 is configured to store various types of data to support the operation at the device 300. Examples of these data include instructions for any application or method operating on the device 300, contact data, phone book data, messages, pictures, videos and the like. The memory 304 may be implemented by any type of volatile or non-volatile storage device or a combination thereof, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The power component 306 provides power to various components of the device 300. The power component 306 may include a power management system, one or more power supplies, and other components associated with generating, managing, and distributing power for the device 300.

The multimedia component 308 includes a screen that provides an output interface between the device 300 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor may not only sense the boundary of the touch or slide action, but also detect the duration and pressure related to the touch or slide operation. In some embodiments, the multimedia component 308 includes a front camera and/or a rear camera. When the device 300 is in an operation mode, such as a shooting mode or a video mode, the front camera and/or the rear camera can receive external multimedia data. Each of the front camera and rear camera may be a fixed optical lens system or have focal length and optical zoom capabilities.

The audio component 310 is configured to output and/or input audio signals. For example, the audio component 310 includes a microphone (MIC), and when the device 300 is in an operation mode, such as a call mode, a recording mode, and a voice recognition mode, the microphone is configured to receive an external audio signal. The received audio signal can be further stored in the memory 304 or sent via the communication component 316. In some embodiments, the audio component 310 further includes a speaker for outputting audio signals.

The I/O interface 312 provides an interface between the processing component 302 and a peripheral interface module. The above-mentioned peripheral interface module may be a keyboard, a click wheel, a button, and the like. These buttons may include but are not limited to home button, volume button, start button, and lock button.

The sensor component 314 includes one or more sensors for providing the device 300 with various aspects of state evaluation. For example, the sensor component 314 can detect the on/off status of the device 300 and the relative positioning of components. For example, the component is a display and keypad of the device 300. The sensor component 314 can also detect the position change of the device 300 or a component of the device 300, the presence or absence of contact between the user and the device 300, the orientation or acceleration/deceleration of the device 300, and the temperature change of the device 300. The sensor component 314 may include a proximity sensor configured to detect the presence of nearby objects when there is no physical contact. The sensor component 314 may also include a light sensor, such as a CMOS or CCD image sensor, for use in imaging applications. In some embodiments, the sensor component 314 may also include an acceleration sensor, a gyroscope sensor, a magnetic sensor, a pressure sensor, or a temperature sensor.

The communication component 316 is configured to facilitate wired or wireless communication between the device 300 and other devices. The device 300 can access a wireless network based on a communication standard, such as WiFi, 2G, or 3G, or a combination thereof. In an embodiment, the communication component 316 receives a broadcast signal or broadcast related information from an external broadcast management system via a broadcast channel. In an embodiment, the communication component 316 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the device 300 may be implemented by one or more of application specific integrated circuit (ASIC), digital signal processor (DSP), digital signal processing device (DSPD), programmable logic devices (PLD), field programmable gate array (FPGA), controller, microcontroller, microprocessor, or other electronic components, to perform the above-mentioned methods.

An embodiment also provides a non-transitory computer-readable storage medium including instructions, such as the memory 304 including instructions, and the instructions may be executed by the processor 320 of the device 300 to complete the foregoing method. For example, the non-transitory computer-readable storage medium may be ROM, random access memory (RAM), CD-ROM, magnetic tape, floppy disk, optical data storage device and the like.

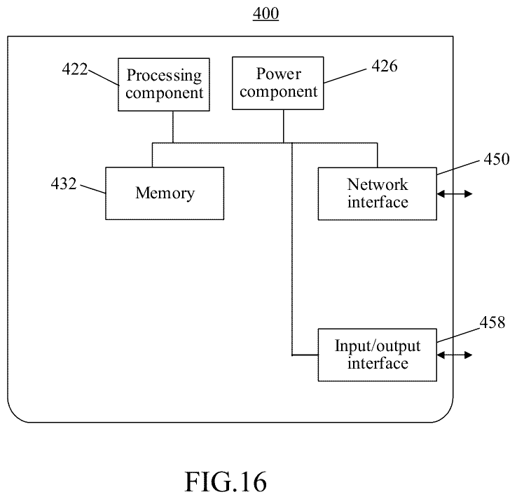

FIG. 16 is a block diagram of a device 400 for wireless communication according to an embodiment. For example, the device 400 may be provided as a server. Referring to FIG. 16, the device 400 includes a processing component 422 which further includes one or more processors, and a memory resource which is represented by a memory 432 and is configured for storing instructions such as application programs executable by the processing component 422. The application program stored in the memory 432 may include one or more modules each corresponding to a set of instructions. Furthermore, the processing component 422 is configured to execute instructions to perform the above methods.

The device 400 may also include a power component 426 configured to perform power management of the device 400, a wired or wireless network interface 450 configured to connect the device 400 to a network, and an input/output (I/O) interface 458. The device 400 may operate based on an operating system stored in memory 432, such as Windows Server™, Mac OS X™, Unix™, Linux™, Free BSD™ or the like.

In an embodiment, the device 400 may be implemented by one or more of application specific integrated circuit (ASIC), digital signal processor (DSP), digital signal processing device (DSPD), programmable logic devices (PLD), field programmable gate array (FPGA), controller, microcontroller, microprocessor, or other electronic components, to perform the above-mentioned methods.

An embodiment also provides a non-transitory computer-readable storage medium including instructions, such as the memory 432 including instructions, and the instructions may be executed by the processing component 422 of the device 400 to complete the foregoing method. For example, the non-transitory computer-readable storage medium may be ROM, random access memory (RAM), CD-ROM, magnetic tape, floppy disk, optical data storage device and the like.

In an embodiment, reporting the wireless communication capability includes: reporting first capability indication information, the first capability indication information being configured to indicate whether the wireless charging capability is supported; and/or reporting second capability indication information, the second capability indication information being configured to indicating whether the wireless sensing capability is supported.

In an embodiment, reporting the wireless communication capability further includes:
reporting first function enablement indication information in response to determining that the terminal supports the wireless charging capability, the first function enablement indication information being configured to indicate whether a wireless charging function is enabled.

In an embodiment, the method further includes: reporting remaining power indication information.

In an embodiment, the method further includes: receiving first indication information transmitted by a network device, the first indication information being configured to indicate enabling or disabling the wireless charging function.

In an embodiment, reporting the wireless communication capability includes: reporting second function enablement indication information in response to the terminal supporting the wireless sensing capability, the second function enablement indication information being configured to indicate whether a wireless sensing function is enabled.

In an embodiment, the method further includes: receiving wireless sensing configuration information transmitted by a network device in response to the terminal supporting the wireless sensing capability and enabling the wireless sensing function; and executing the wireless sensing function based on the wireless sensing configuration information.

In an embodiment, reporting the wireless communication capability includes: reporting terminal capability information, the terminal capability information carrying the wireless communication capability.

In an embodiment, receiving the wireless communication capability reported by the terminal includes: receiving first capability indication information, the first capability indication information being configured to indicate whether the wireless charging capability is supported; and/or receiving second capability indication information, the second capability indication information being configured to indicate whether the wireless sensing capability is supported.

In an embodiment, receiving the wireless communication capability reported by the terminal further includes: receiving first function enablement indication information reported by the terminal, the first function enablement indication information being configured to indicate whether a wireless charging function is enabled.

In an embodiment, the method further includes: receiving remaining power indication information reported by the terminal.

In an embodiment, the method further includes: transmitting first indication information, the first indication information being configured to indicate enabling or disabling the wireless charging function.

In an embodiment, receiving the wireless communication capability reported by the terminal includes: receiving second function enablement indication information reported by the terminal, the second function enablement indication information being configured to indicate whether a wireless sensing function is enabled.

In an embodiment, the method further includes: transmitting wireless sensing configuration information in response to the terminal supporting the wireless sensing capability and enabling the wireless sensing function.

In an embodiment, receiving the wireless communication capability reported by the terminal includes: receiving terminal capability information, the terminal capability information carrying the wireless communication capability.

In an embodiment, the transmitting unit reports first capability indication information, the first capability indication information being configured to indicate whether the wireless charging capability is supported; and/or report second capability indication information, the second capability indication information being configured to indicating whether the wireless sensing capability is supported.

In an embodiment, the transmitting unit reports first function enablement indication information in response to the processing unit determining that the terminal supports the wireless charging capability, the first function enablement indication information being configured to indicate whether a wireless charging function is enabled.

In an embodiment, the transmitting unit is further configured to report remaining power indication information.

In an embodiment, the wireless communication device further includes a receiving unit configured to receive first indication information transmitted by a network device, and the first indication information is configured to indicate enabling or disabling the wireless charging function.

In an embodiment, the transmitting unit reports second function enablement indication information in response to the processing unit determining that the terminal supports the wireless sensing capability, and the second function enablement indication information is configured to indicate whether a wireless sensing function is enabled.

In an embodiment, the wireless communication device further includes a receiving unit configured to receive wireless sensing configuration information transmitted by a network device in response to the terminal supporting the wireless sensing capability and enabling the wireless sensing function; and execute the wireless sensing function based on the wireless sensing configuration information.

In an embodiment, the transmitting unit reports terminal capability information, the terminal capability information carrying the wireless communication capability.

In an embodiment, the receiving unit receives first capability indication information, the first capability indication information being configured to indicate whether the wireless charging capability is supported; and/or receives second capability indication information, the second capability indication information being configured to indicate whether the wireless sensing capability is supported.

In an embodiment, the receiving unit is further configured to receive first function enablement indication information reported by the terminal, and the first function enablement indication information is configured to indicate whether a wireless charging function is enabled.

In an embodiment, the receiving unit is further configured to receive remaining power indication information reported by the terminal.

In an embodiment, the wireless communication device further includes a transmitting unit configured to transmit first indication information, and the first indication information is configured to indicate enabling or disabling the wireless charging function.

In an embodiment, the receiving unit receives second function enablement indication information reported by the terminal, and the second function enablement indication information is configured to indicate whether a wireless sensing function is enabled.

In an embodiment, the wireless communication device further includes a transmitting unit configured to transmit wireless sensing configuration information in response to the terminal supporting the wireless sensing capability and enabling the wireless sensing function.

In an embodiment, the receiving unit is configured to receive terminal capability information, and the terminal capability information carries the wireless communication capability.

The term “plurality” in the present disclosure means two or more, and other quantifiers are similar. The term “and/or”, describing the association of associated objects, indicates that three relationships can exist, for example, A and/or B, which can indicate the presence of A alone, A and B together, and B alone. The character “/” generally indicates an “or” relationship between the preceding and following associated objects. The singular forms “a”, “said” and “the” are also intended to include plural forms, unless the context clearly indicates otherwise.

The terms “first”, “second” and the like are used to describe a variety of information, but that such information should not be limited to these terms. These terms are only used to distinguish information of the same type from one another and do not indicate a particular order or level of importance. In fact, the expressions “first” and “second” may be used interchangeably. For example, without departing from the scope of the present disclosure, first information may also be referred to as second information, and similarly, second information may also be referred to as first information.

Although the operations are depicted in the accompanying drawings in a particular order in embodiments of the present disclosure, this should not be construed as requiring that the operations be performed in the particular order shown or in serial order, or that all of the operations shown be performed to obtain the desired results. Multitasking and parallel processing may be advantageous in particular environments.

The present disclosure is intended to cover any variations, uses, or adaptations of the present disclosure that follow the general principles of the present disclosure and include the common general knowledge or conventional technical means in the technical field not disclosed by the present disclosure.

The present disclosure is not limited to the precise structures described above and illustrated in the accompanying drawings, and that various modifications and changes may be made without departing from the scope thereof. The scope of the present disclosure is limited only by the appended claims.

1. A wireless communication method, comprising:
determining, by a terminal, a wireless communication capability supported by the terminal, the wireless communication capability comprising at least one of a wireless charging capability or a wireless sensing capability; and
reporting, by the terminal, the wireless communication capability.

2. The method according to claim 1, wherein reporting the wireless communication capability comprises at least one of:
reporting first capability indication information, the first capability indication information being configured to indicate whether the wireless charging capability is supported;
reporting second capability indication information, the second capability indication information being configured to indicating whether the wireless sensing capability is supported.

3. The method according to claim 2, wherein reporting the wireless communication capability further comprises:
reporting first function enablement indication information in response to determining that the terminal supports the wireless charging capability, the first function enablement indication information being configured to indicate whether a wireless charging function is enabled.

4. The method according to claim 1, further comprising:
reporting, by the terminal, remaining power indication information.

5. The method according to claim 3, further comprising:
receiving, by the terminal, first indication information transmitted by a network device, the first indication information being configured to indicate enabling or disabling the wireless charging function.

6. The method according to claim 2, wherein reporting the wireless communication capability comprises:
reporting second function enablement indication information in response to the terminal supporting the wireless sensing capability, the second function enablement indication information being configured to indicate whether a wireless sensing function is enabled.

7. The method according to claim 6, further comprising:
receiving, by the terminal, wireless sensing configuration information transmitted by a network device in response to the terminal supporting the wireless sensing capability and enabling the wireless sensing function; and
executing, by the terminal, the wireless sensing function based on the wireless sensing configuration information.

8. The method according to claim 1, wherein reporting the wireless communication capability comprises:
reporting terminal capability information, the terminal capability information carrying the wireless communication capability.

9. A wireless communication method, comprising:
receiving, by a network device, a wireless communication capability reported by a terminal, the wireless communication capability comprising at least one of a wireless charging capability or a wireless sensing capability.

10. The method according to claim 9, wherein receiving the wireless communication capability reported by the terminal comprises at least one of:
receiving first capability indication information, the first capability indication information being configured to indicate whether the wireless charging capability is supported; or
receiving second capability indication information, the second capability indication information being configured to indicate whether the wireless sensing capability is supported.

11. The method according to claim 10, wherein receiving the wireless communication capability reported by the terminal further comprises:
receiving first function enablement indication information reported by the terminal, the first function enablement indication information being configured to indicate whether a wireless charging function is enabled.

12. The method according to claim 9, further comprising:
receiving, by the network device, remaining power indication information reported by the terminal.

13. The method according to claim 11, further comprising:
transmitting, by the network device, first indication information, the first indication information being configured to indicate enabling or disabling the wireless charging function.

14. The method according to claim 10, wherein receiving the wireless communication capability reported by the terminal comprises:
receiving second function enablement indication information reported by the terminal, the second function enablement indication information being configured to indicate whether a wireless sensing function is enabled.

15. The method according to claim 14, further comprising:
transmitting, by the network device, wireless sensing configuration information in response to the terminal supporting the wireless sensing capability and enabling the wireless sensing function.

16. The method according to claim 9, wherein receiving the wireless communication capability reported by the terminal comprises:
receiving terminal capability information, the terminal capability information carrying the wireless communication capability.

17-18. (canceled)

19. A wireless communication device, comprising:
a processor; and
a memory storing instructions executable by the processor,
wherein the instructions, when being executed by the processor, cause a terminal to implement actions comprising:
determining a wireless communication capability supported by the terminal, the wireless communication capability comprising at least one of a wireless charging capability or a wireless sensing capability; and
reporting the wireless communication capability.

20. A wireless communication device, comprising:
a processor; and
a memory storing instructions executable by the processor,
wherein the instructions, when being executed by the processor, cause a network device to implement the method according to claim 9.

21-22. (canceled)

23. The device according to claim 19, wherein reporting the wireless communication capability comprises at least one of:
reporting first capability indication information, the first capability indication information being configured to indicate whether the wireless charging capability is supported; or
reporting second capability indication information, the second capability indication information being configured to indicating whether the wireless sensing capability is supported.

24. The device according to claim 23, wherein reporting the wireless communication capability further comprises:
reporting first function enablement indication information in response to determining that the terminal supports the wireless charging capability, the first function enablement indication information being configured to indicate whether a wireless charging function is enabled.
